(19) United States
(12) Patent Application Publication
(10) Pub. No.: US 2020/0058031 A1
(43) Pub. Date: Feb. 20, 2020

(54) INJECTING USER CONTROL FOR CARD-ON-FILE MERCHANT DATA AND RECURRING PAYMENT TRANSACTION PARAMETERS BETWEEN ACQUIRER PROCESSORS AND ISSUER PROCESSORS OVER DATA COMMUNICATION NETWORKS

(71) Applicant: Ondot Systems, Inc., San Jose, CA (US)

(72) Inventors: Zhiqiang Zhang, San Ramon, CA (US); Vaduvur Bharghavan, Morgan Hill, CA (US)

(21) Appl. No.: 16/551,166

(22) Filed: Aug. 26, 2019

Related U.S. Application Data
(63) Continuation-in-part of application No. 16/227,560, filed on Dec. 20, 2018.
Application No. 16/227,560 is a continuation-in-part of application No. 14/058,229, filed on Oct. 19, 2013.
Application No. 14/058,229 is a continuation-in-part of application No. 13/527,544, filed on Jun. 19, 2012.
Application No. 16/227,560 is a continuation-in-part of application No. 13/527,544, filed on Jun. 19, 2012.
Application No. 13/527,544 is a continuation-in-part of application No. 14/058,229, filed on Oct. 19, 2013.

(51) Int. Cl. G06Q 20/40; G06Q 20/42; G06Q 20/10

(52) U.S. Cl. CPC G06Q 20/4093; G06Q 20/4097; G06Q 20/102; G06Q 20/42; G06Q 20/405

(57) ABSTRACT

Updates to a payment card of the specific card user that will affect subsequent payments to the COF merchants has occurred are detected based on receiving a notification from an issuer processor. In response, payment credentials can be automatically updated with the COF merchants for the specific card user.

### CROSS-REFERENCE TO RELATED APPLICATIONS

This application claims priority under 35 USC 120 as a continuation-in-part of co-pending U.S. application Ser. No. 13/527,544 filed Jun. 19, 2012 entitled SYSTEM AND METHOD FOR PAYMENT AUTHORIZATION CONTROL, by Rachna Ahlawat, as a continuation-in-part to U.S. application Ser. No. 14/058,229 filed Oct. 19, 2013 entitled SYSTEM AND METHOD FOR AUTHORIZING A TRANSACTION BASED ON DYNAMIC LOCATION UPDATES FROM A USER DEVICE, by Vaduvur Bharghavan, and as a continuation-in-part to U.S. application Ser. No. 16/227,560 filed Dec. 20, 2018 entitled REAL-TIME ENRICHMENT OF RAW MERCHANT DATA FROM ISO TRANSACTIONS ON DATA COMMUNICATION NETWORKS FOR PREVENTING FALSE DECLINES IN FRAUD PREVENTION SYSTEMS, which are hereby incorporated by reference in their entirety.

### FIELD OF THE INVENTION

The invention relates generally, to computer networking security, and more specifically, to injecting user control for user card updates automatically applied to card-on-file merchant data and recurring payment transaction parameters between acquirer processors and issuer processors over data communication networks.

### BACKGROUND

On the one hand, card users rely upon availability of electronic funds for point-of-sale and online purchases with merchants. When an electronic payment fails due to issues within the system, apart from actual availability of electronic funds, card users can have services disrupted, purchases failed, and even be embarrassed in front of friends. One case of failed user card transactions arises when there is a change in the underlying user card being used for the transaction. For example, if an existing card is lost or stolen, and a new physical card is typically issued by mail to the address on file and, after receipt, the card user manually updates the card information. In the meantime, no electronic payments can be consummated.

On the other hand, card users may be suspicious of COF (card on file) merchants that store the user card information so that the user does not have to reenter for each use. In the case of recurring payments, COF merchants automatically consummate charges for a predetermined amount at a predetermined frequency, such as monthly dues for a health club membership. If a user is suspicious, card users have a lack of control over COF merchants and recurring payments. The conventional options for control are to submit a dispute with the credit card company or the merchant. But this can be time consuming and complicated.

Thus, users have a lack of control over COF merchants and recurring payments. For example, attempts to make a recurring charge to a lost or stolen card may be unintentionally made if the card user is not able to update with the new physical card in time. The unintentional transaction should be rejected by a financial transaction system. The failed transactions can raise red flags by the COF merchant or recurring transaction processor with respect to the card user. In turn, red flags can also be raised by an acquirer processor or issue processor with respect to the COF merchant or recurring transaction processor. The result can lead to service or product cancelations, late fees, bad faith, and other consequences. There can also be a chilling effect on conducting online transactions.

What is needed is a robust technique for improving user card data stored by card-on-file merchants and recurring payment transactions between acquirer processors and issuer processors over data communication networks, in cases such as updated card information and other cases discussed herein.

### SUMMARY

To address the above-mentioned shortcomings, methods, computer-readable mediums, and devices are provided for injecting user control to card-on-file merchant data and recurring payment transactions between acquirer processors and issuer processors over data communication networks.

In an embodiment, a database of transactions is formed form forwarded transactions from financial institutions, the forwarded transactions transmitted from an acquirer processor for approval by an issuer processor. A transaction classifier can be trained from the database of transactions to identify COF (card on file) merchants having payment credentials on file for a specific card user, and participating in account update services for a financial institution. The resulting list of the COF merchants and associated transactions, along with action buttons related to the COF merchants can be provided to card users as well as an ISO transaction approval system.

In another embodiment, updates to a card of the specific card user that will affect subsequent payments to the COF merchants has occurred are detected based on receiving a notification from an issuer processor. In response, payment credentials can be automatically updated with the COF merchants for the specific card user

Advantageously, the technical field of network security is improved by reducing falsely declined transactions.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system for injecting user control for user card updates automatically applied to COF merchants and recurring payment transactions of an ISO transaction approval system, according to an embodiment.

FIG. 2 is a sequence diagram illustrating interactions between the components of the system of FIG. 1, according to an embodiment.

FIG. 3 is a more detailed block diagram illustrating a user control server of the system of FIG. 1, according to some embodiments.

FIG. 4 is a more detailed block diagram illustrating a data enrichment server of the system of FIG. 1, according to some embodiments.

FIG. 5 is a high-level flow diagram illustrating a method for injecting user control for user card updates automatically applied to COF merchants and recurring payment transactions of an ISO transaction approval system, according to an embodiment.

FIG. 6 is a high-level flow diagram illustrating a step of discovering COF merchants and recurring payments, in the method of FIG. 5, according to an embodiment.

FIG. 7 is a high-level flow diagram illustrating a step of providing a list of COF merchants and recurring payments to card users and to transaction approval system, in the method of FIG. 5, according to an embodiment.

FIG. 8 is a high-level flow diagram illustrating a step of enriching raw merchant data of an authorization request with normalized merchant data according to user location, in the method of FIG. 7, according to an embodiment.

FIG. 9 is a table illustrating an example of user controls for the list of COF merchants and recurring payments displayed on an app of card users, according to an embodiment.

FIG. 10 is a block diagram illustrating an example computing device, according to one embodiment.

### DETAILED DESCRIPTION

Systems with computer hardware devices, computer-implemented methods, and (non-transitory) computer-readable mediums, for injecting user control to card-on-file merchant data and recurring payment transactions between acquirer processors and issuer processors over data communication networks, are disclosed.

The examples detailed herein are non-limiting and concise. For instance, although false declines are referred to herein as a technology that is improved by the techniques disclosed below, many other technologies such as dispute resolution and user card controls, are also improved. Moreover, merchant transactions in the ISO 8583 format for network data packets can also be applied to non-merchant transactions and other packet formats.

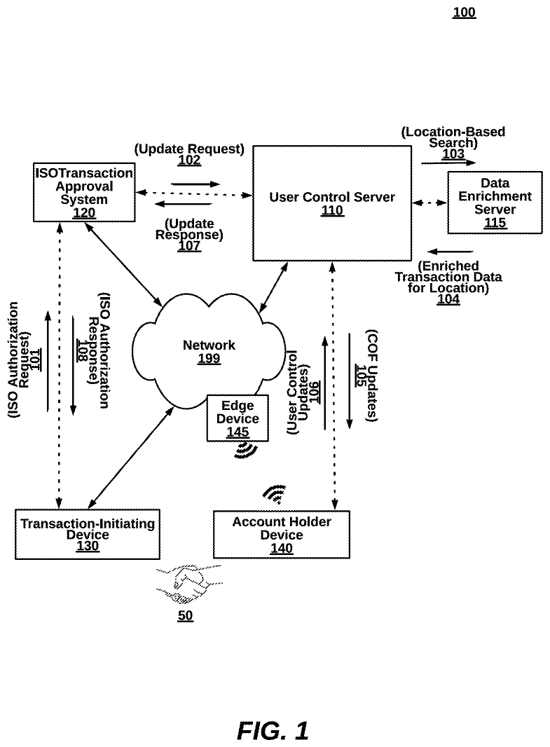

I. System for Injecting User Control to COF User Card Data and Transaction Parameters (FIGS. 1-4)

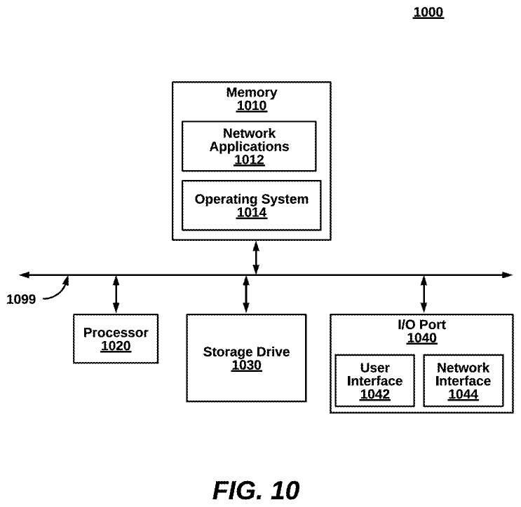

FIG. 1 is a high-level block diagram illustrating a system 100 for injecting user control (e.g., for user card updates automatically) applied to COF merchants and recurring payment transactions of an ISO transaction approval system, according to an embodiment. The system 100 primarily comprises a user control server 110, a transactional approval system 120, a transaction-initiating device 130 and an account holder device 140. Additional network components can also be part of the system 100, such as firewalls, virus scanners, routers, switches, application servers, databases, data lakes, data warehousing, as well as additional controllers, access points, access switches, stations, SDN (Software-Defined Networking) controllers, Wi-Fi controllers, and the like. The network components can be implemented as hardware, software, or a combination of both, for example, as described with respect to the computing environment of FIG. 10.

Each of the primary components are coupled in communication through a network 199. The account holder device 140 may be a mobile device using Wi-Fi or cellular, for example, that couples to an edge device 149 for access to the network 199. The network 199 may be the Internet, a wide area network, a local area network, or a cellular network (e.g., 3G, 4G or 5G) in one case, and may be a hybrid network in another case.

The user control server 110, in one embodiment, receives an update request 102 along with a copy of an ISO authorization request 101 and responds with an update response 102. The update response 102 can include a new user card number, a new expiration date, a product upgrade, information from a portfolio conversion, user controls, or the like. To determine updates, the user control server 110 continually classifies ISO transactions to identify COF merchants and recurring payments associated with a particular user card. A list of COF merchants and recurring payments is determined, and updated as new ISO transactions are classified. The user control server 110 can provide the list of COF merchants and recurring payments back to elements of the ISO transaction approval system 120, such as a financial institution or issuer processor. COF merchants, as referred to herein, store user card data used by a merchant device to fund purchases that are either automatically triggered (Amazon Prime annual fee) or manually triggered (e.g., Amazon toy purchase). Further, recurring transactions are subset of transactions conducted by the COF merchant. A transaction is recurring if it is automatically conducted at some frequency for a standard amount. The Amazon Prime annual fee may be charged on May 1st of each year with the same card data, recurring, and without new authorization from the card holder. In one embodiment, besides detecting recurring merchants (merchant-level insights), it can also detect recurring insights at the combination of card and merchant level. So, for each card and merchant information, frequency, trial end date, next billing date, and estimated amount, are known based on history.

In an embodiment, updates to a specific user card are received and processed by the user control server 110. The updates can be initiated by financial institutions or issuer processors or by users themselves. For example, when a new user card is requested or automatically dispatched by mail to a Chase card holder, Chase can immediately send updated card information to the user control server 110 over a secure channel before the Chase card holder is even aware that the new user card exists. The update, in turn, can be applied to the list of COF and recurring payments in either a push or pull distribution. The user can also be notified of COF updates 105 and make decisions to inject control how the new information is disseminated. In some cases, a card user may be suspicious of a particular merchant or POS type and wish to discontinue by precluding the update. A user app on the account holder device 140 with a touch screen button can be pressed, thereby providing card users with easy access to a traditionally closed loop ISO transaction approval system 120.

The data enrichment server 115, in one embodiment, extracts raw merchant data from the ISO authorization request for conversion to enriched merchant data for the list of merchants. The raw merchant data is typically customized by a particular merchant and their business practice, or there is any protocol at all. Enriched merchant data, on the other hand, is normalized with known commercial names. This prevents several different COF merchant entries for a common merchant, for example, at different locations. While raw merchant data can have 2, 10 or more variations, enriched merchant data is coalesced under a single entry. When a customer wants to cancel a recurring payment at Walmart, for example, all the transactions and actions are accessible under a single commercial name rather than having to individually check each name and decipher raw merchant data. Some merchants have more than one enriched merchant names, such as Amazon Prime and Amazon. In one embodiment, the data enrichment server 115 is an optional part of the system 100.

For the data enrichment option, the user location 103 for the account holder device 140 can be pushed or pulled and utilized to filter search results of a places server. For example, a data field has WLMRT within close proximity to a known Walmart store, the custom abbreviation can be enriched to the common trade name. The location is preferably in real-time with data enrichment, but in some cases, is done asynchronously. GPS, Wi-Fi triangulation, IP address analyses, or other techniques at the account holder device 140 determines local geo-coordinates and sends to the data enrichment server 115. In one case, the data enrichment server 115 uses algorithms to predict the location based on previous locations. In another case, the data enrichment server 115 infers location from the merchant location, IP address, or any other appropriate technique.

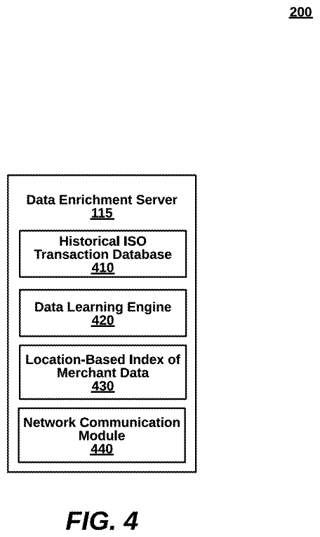

In some embodiments, the data enrichment server 115 is part of a third-party fraud detection system, separate from the card updater system or the transaction approval system 120. In other embodiments, the data enrichment server 115 can be integrated with the user control server 110. The data enrichment server 115 is set forth in more detail with respect to FIG. 4 below.

The transactional approval system 120, in an embodiment, is a backend to a payment authorization system for credit card transactions for a merchant. The transactions can be financial transactions, such as a credit card approval, a debit card approval, an ACH, or other financial transactions. In other embodiments, the transactions are non-financial. The financial transaction approval system can include an acquirer processor, a card network, an issuer processor, a card issuer, and an account host. Responsive to a transaction initiated at the merchant, the acquirer processor can send the ISO authorization request according to the ISO 8583 standard, including a x100 or a x200 message type, with a transaction card number, transaction card credentials, merchant information, transaction amount, and other mandatory and optional fields. The card network does validity checks on the ISO authorization request and involves any additional services the acquirer or issuer have signed up for (such as address validation, PIN validation, risk scoring, and the like), and then forward the ISO authorization request to the issuer processor. The issue processor can perform validity checks and invoke value-added services such as risk scoring and cardholder policy checks, before checking with an account host if a user account has adequate funds to satisfy a transaction request. The account host responds to the issuer processor with an approval or denial that the issuer processor can form into an ISO authorization response, along with a approve or denial reason code. The card network forwards the ISO authorization response to the acquirer processor, and in turn, back to the merchant at the POS. Many other approval systems are possible.

In one embodiment, the transactional approval system 120 subscribes to the user control server 110 for updates to user card data. For instance, an update service can check for any changes to user card data stored by a merchant device. Data can be pushed through a subscription, or data can be pulled by merchant checks.

Conventional payment authorization systems typically block out the account holder device 140 from participation in approvals through payment controls. By contrast, the user control server 110 is able to implement controls of the account holder device 140 by registering a user account with a third party administrating the data enrichment server 115.

In an alternative embodiment, a third-party COF server (not shown) provides user control of COF merchants outside of the ISO transactional approval system 120. In other words, one embodiment bypasses the traditional financial system for managing COF merchants and recurring transactions.

The transaction-initiating device 130, can be a merchant device or other POS, where a merchant swipes a transaction card through a transaction card reader which uses transceiver coupled to the network 199 for transmitting an ISO authorization request to the transaction approval system 120 for approval. In an embodiment, the transaction-initiating device 130 is a COF merchant storing user card data, for various reasons. In one instance, Amazon stores user cards for easy check out. In another instance, Spotify stores user cards, and charges a premium service fee at the same time of each month, for the same amount each month. Some COF transactions are recurring transactions. One implementation of the transaction-initiating device 130 is a terminal at a gym using Stripe to charge for membership services. The card may be stored for monthly fees. If the case of updated user card data, the transaction-initiating device 130 avoids declines by pushing the update initiated by a user.

The account holder device 140 for a purchaser, for example, can be a user device such as a mobile telephone, electronic payment device, an iPad, laptop computer, or the like. The purchaser or other user logs onto the data enrichment server 110 with authentication credentials to create a secure channel for location sharing, changing transaction controls, and managing transactions. In one implementation, a mobile application is downloaded to the account holder device 140 for communication with the user control server 110. In another embodiment, an operating system or Bluetooth-connected device communicates with the data enrichment sever 110.

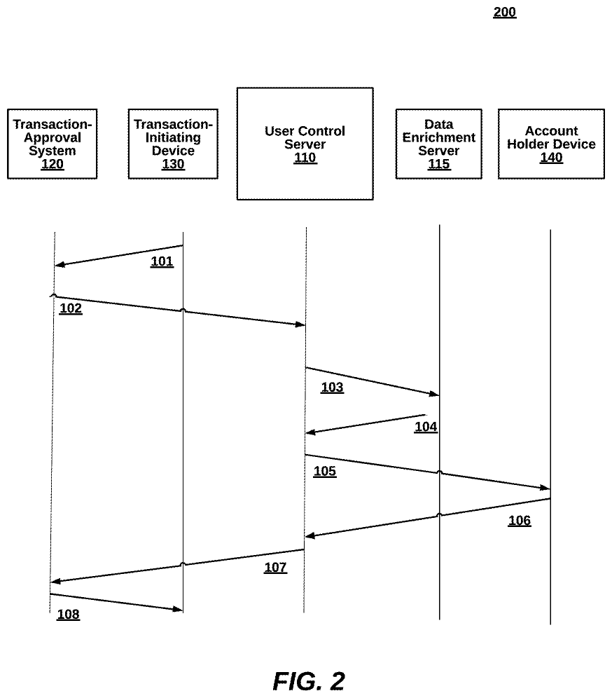

FIG. 2 is a sequence diagram illustrating interactions between the components of the system of FIG. 1, according to an embodiment. Variations in the sequence are possible. For instance, real-time card updates and real-time user controls are shown in the interactions of FIG. 2. However, in other embodiments, updates can be pulled from the user control server 110 in batch mode. In still other embodiments, user COF controls are applied separately from real-time ISO transactions.

At interaction 101, the transaction-initiating device 130 receives data from a payment card swipe by the merchant or the user (or Apple Pay, an NFC contactless swipe, or otherwise) thereby initiating the network security techniques described herein. Data packets including an ISO authorization request are sent to the transactional-approval system. The transmission channel can be, for example, an end-to-end wired connection, a Wi-Fi or other wireless connection, or a hybrid network.

At interaction 102, an update request checks for COF or recurring payment updates by sending a copy of the ISO authentication request. In turn, a location-based search query is sent to the place server 115 at interaction 103 and a response is sent back at interaction 104. The list of merchants compiled from enriched data can be sent as COF updates, at interaction 105, to the account holder device. User actions, user payment controls, geographical fencing, or charge amount limitations, or other processes can be applied at this point and are sent as user COF controls, at interaction 106, from the account holder device 150 back to the user control server 110. At interaction 107, an update response is sent back to the transaction approval system 120. At interaction, 108 the ISO authorization response is sent to the transaction-initiating device 130. In response, a release of goods to the user can be allowed or disallowed by the merchant, in one example.

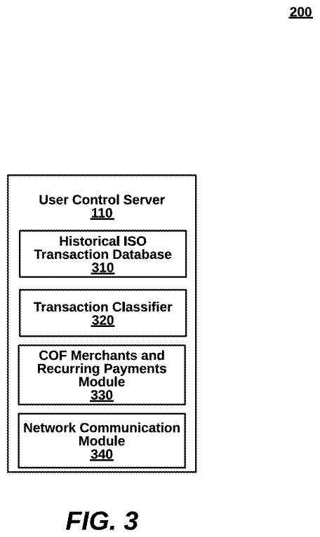

FIG. 3 is a more detailed block diagram illustrating a user control server of the system of FIG. 1, according to some embodiments. The data enrichment server 110 includes a historical ISO transactional database 310, a transaction classifier 320, a COF merchants and recurring payments module 330, and a network communication module 340. The components can be implemented in hardware, software, or a combination.

The historical ISO transactional database 310 stores previous ISO authentication requests and responses for training the transaction classifier 320. The previous transactions can be limited to a specific user, a specific location (e.g., zip code, city or state), a specific transaction type (e.g., recurring transactions), or as otherwise needed for a specific implementation.

The transaction classifier 320 can use statistical modeling to identify COF merchants and recurring payments. One instance uses discrete Fourier transformational power spectral density for accurate and deep learning from the past ISO transactions. To do so, transactions are projected onto the frequency (sinusoids) domain. Perfectly sinusoidal data will have one spike. Periodic yet not sinusoidal data will have one spikes at the integer multiple of the frequency. Noise will have no spike, indicative of no recurring payments. Further, a periodgram/PSD involves the square of the magnitude of discrete Fourier transform to provide a good estimation from energy concentrated around certain frequencies.

Other instances of the transactional classifier 320 can also incorporate a simple moving average, exponential smoothing, ARIMA, SARIMA, or RNNs either separately or in combination with spectral density analysis. In still other instances a flag is set in the data field 58.4 of the ISO 8583 format, or alternatively or in combination with, flags in data field 22 for POS entry mode and field 126 for POS environmental, and other variations. The data field 58.4 flag indicates that a recurring transaction is occurring. This self-identification of COF merchants can also be added to the COF list and the recurring transactions list. Other flags can include data field 61, for instance. In still another embodiment, a recurring transaction is identified when a first transaction includes account verification with a CVV2 or security code indicator set and subsequent transactions are higher than $0 do not include a CVV2.

The COF merchants and recurring payments module 330 compiles, updates and distributes the list of COF merchants and recurring payments, in an embodiment. A user interface can communicate with the account holder device 140 to provide a display to card users to verify and control. The user interface can provide settings for notifications about updates to the user. At the same time, subscriptions to the update servers with financial institutions, and other aspects of the transaction system 120.

The network communication module 340 can include a network interface, transceivers, antenna, protocol software, APIs and other aspects necessary

FIG. 4 is a more detailed block diagram illustrating a data enrichment server 115 of FIG. 1, according to some embodiments. The data enrichment server 115 includes a historical ISO transactional database 410, a data learning engine 420, a location-based index of merchant data 430 and a network communication module 440. The components can be implemented in hardware, software, or a combination.

The historical ISO transactional database 410 stores previous ISO authentication requests and responses for training the data learning engine 420. The previous transactions can be limited to a specific user, a specific location (e.g., zip code, city or state), a specific transaction type (e.g., recurring transactions), or as otherwise needed for a specific implementation. In an alternative embodiment, the historical ISO transactional database 410 stores previous ISO authentication request for other users. As a result, recurring transactions can be identified for a particular user from historical information and patterns of others. This is particularly useful for identifying recurring payments from a first payment of the series, for example.

The location-based index of merchant data 430 is generated from the learning process as varying merchant names are coalesced under a single name, and payment controls are implemented through the single name. Being local to the data enrichment server 115, one embodiment provides real-time look-up of enriched merchant data and when there is a cache miss, raw merchant data is used for making decisions. The enriched data can be retrieved from a places server. Preferably, the data enrichment server 115 is under independent control from the transaction approval system 120. As a result, the location-based index is controlled and leveraged by the user typically precluded from the ISO transaction data path.

The network communication module 440 can include a network interface, transceivers, antenna, protocol software, APIs and other aspects necessary

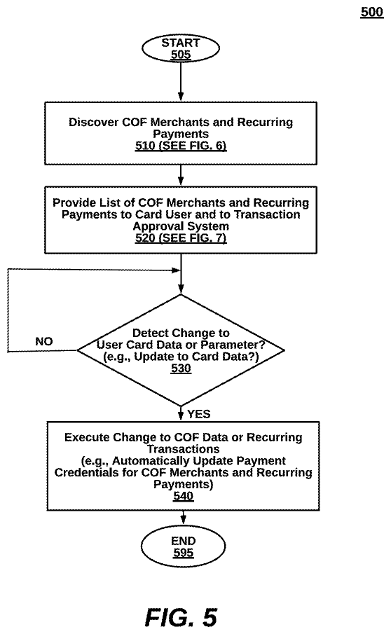

II. Methods for Injecting User Control to COF User Card Data and Transaction Parameters (FIGS. 5-9)

FIG. 5 is a high-level flow diagram illustrating a method for injecting user control for user card data (e.g.,user card updates) automatically applied to COF merchants and recurring payment transactions of an ISO transaction approval system, according to an embodiment. The steps herein are merely example groupings of functionality that can be performed in different orders, enhanced with other steps, and otherwise modified under the spirit of the present disclosure.

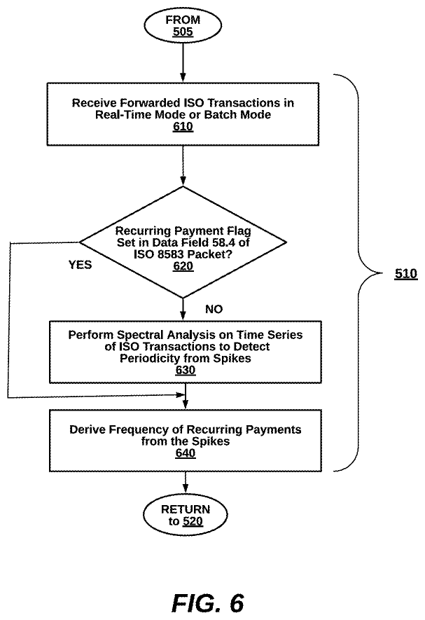

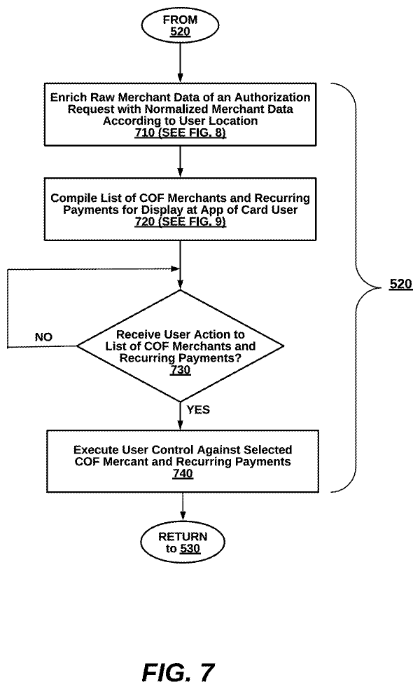

At step 510, COF merchants and recurring payments are discovered, as described in more detail with respect to FIG. 6. At step 520, a list of COF merchants and recurring payments are provided to card users and/or to a transaction approval system, as shown with further detail in FIG. 7. If a change to user card data or parameter is detected (e.g., an update to a card for a specific card user is detected) at step 530, at step 540 payment credentials for COF merchants and recurring payments are automatically updated, as described throughout the disclosure.

FIG. 6 is a high-level flow diagram illustrating a step of discovering COF merchants and recurring payments, in the method of FIG. 5, according to an embodiment. At step 610, ISO transactions are forwarded in real-time or batch mode for analysis. If a recurring payment flag is set, for example in data field 58.4 of an ISO 8583 format packet at step 620, the merchant is added to the COF merchant list. Another embodiment uses alternative data fields for the recurring data for format various (e.g., between US non-US countries), such as data field 60 and data field 126. If a recurring payment flag is not set at step 620, at step 630, spectral analysis is performed on a time series of ISO transactions to detect recurring payments. Other embodiments perform spectral analysis even if the flag is set, in order to determine a frequency (e.g., daily, weekly, monthly). Besides spectral analysis, in other embodiments, different transaction attributes are analyzed. Next, at step 640, a frequency of recurring payments is derived from the spikes of the spectral analysis. In one embodiment, step 640 is not performed due to poor results in the spectral analysis of step 630. For example, there may be no detected periodicity detected from spikes when the spectral analysis is performed. The process then returns to step 520 of FIG. 5.

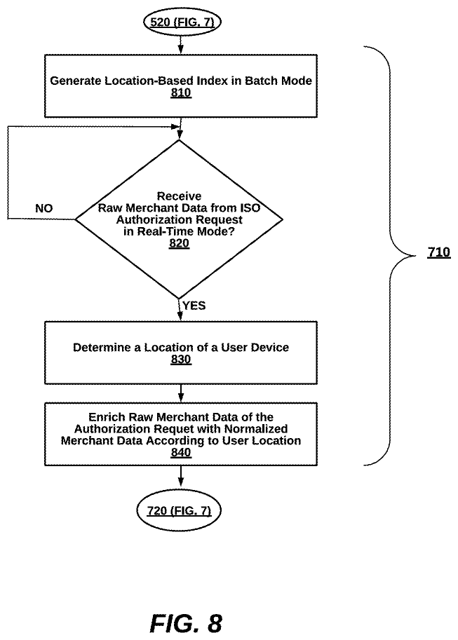

FIG. 7 is a high-level flow diagram illustrating a step of providing a list of COF merchants and recurring payments to card users and to transaction approval system, in the method of FIG. 5, according to an embodiment. At step 710, raw merchant data of an authorization request is enriched with normalized merchant data according to a user location, as set forth below in association with FIG. 8. At step 720, a list of COF merchants and recurring payment is compiled for display at, for example, a mobile app on a smartphone of the card user. If user actions to list of COF merchants and recurring payments is received at step 730, at step 740, the user control (e.g., cancel, update or limit) is executed against COF merchant and recurring payments. The process returns to step 530 of FIG. 5

FIG. 8 is a high-level flow diagram illustrating a step of enriching raw merchant data of an authorization request with normalized merchant data according to user location, in the method of FIG. 7, according to an embodiment.

At step 810, a location-based index is generated in batch mode. At step 820, responsive to receiving raw merchant data parsed from an ISO authorization request for a transaction in process, a location of a user device is determined at step 830. At step 840, raw merchant data is enriched with normalized merchant data according to the user location.

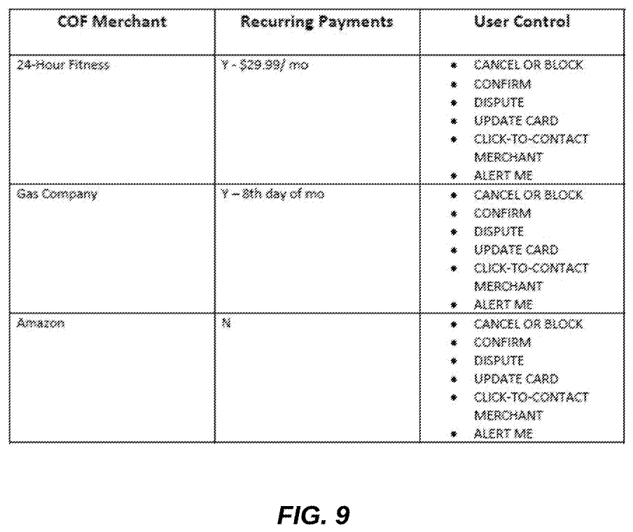

FIG. 9 is a table illustrating an example of user controls for the list of COF merchants and recurring payments displayed on an app of card users, according to an embodiment. As shown, COF merchants are listed, some of which have associated recurring payments (i.e., 24-hour Fitness at $29.99 per month, and gas company billing on the 8th day of the month, although amounts may be different) and some do not have associated recurring payments (i.e., Amazon stored a card but purchases are not necessarily periodic in amount or date). Further, user controls allow a direct action to the COF merchant such as canceling the COF information, confirming the recurring payment, limiting charges by geo-location or amount, updating the card, clicking to contact the merchant, and alerting the user. The user can update the card or give permission to the card updater to do so automatically. Many other variations are possible.

III. Processor-Driven Computing Device (FIG. 10)

FIG. 10 is a block diagram illustrating an exemplary computing device 1000 for use in the system 100 of FIG. 1, according to one embodiment. The computing device 1000 is an exemplary device that is implementable for the user control server 110, each of the components of ISO transactional system 120, the transaction-initiating device 130, or the account holder device 140. Additionally, the computing device 1000 is merely an example implementation itself, since the system 100 can also be fully or partially implemented with laptop computers, tablet computers, smart cell phones, Internet appliances, and the like.

The computing device 1000, of the present embodiment, includes a memory 1010, a processor 1020, a storage drive 1030, and an I/O port 1040. Each of the components is coupled for electronic communication via a bus 1099. Communication can be digital and/or analog, and use any suitable protocol.

The memory 1010 further comprises network applications 512 and an operating system 1014. The network applications 1012 can include a web browser, a mobile application, an application that uses networking, a remote application executing locally, a network protocol application, a network management application, a network routing application, or the like.

The operating system 1014 can be one of the Microsoft Windows®. family of operating systems (e.g., Windows 95, 98, Me, Windows NT, Windows 2000, Windows XP, Windows XP x104 Edition, Windows Vista, Windows CE, Windows Mobile), Windows 7, Windows 8, Linux, HP-UX, UNIX, Sun OS, Solaris, Mac OS X, Alpha OS, AIX, IRIX32, or IRIX104. Other operating systems may be used. Microsoft Windows is a trademark of Microsoft Corporation.

The processor 1020 can be a network processor (e.g., optimized for IEEE 802.11), a general-purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 1020 can be single core, multiple core, or include more than one processing elements. The processor 1020 can be disposed on silicon or any other suitable material. The processor 1020 can receive and execute instructions and data stored in the memory 1010 or the storage device 1030.

The storage device 1030 can be any non-volatile type of storage such as a magnetic disc, EEPROM, Flash, or the like. The storage device 1030 stores code and data for applications.

The I/O port 1040 further comprises a user interface 1042 and a network interface 1044. The account holder interface 1042 can output to a display device and receive input from, for example, a keyboard. The network interface 1044 connects to a medium such as Ethernet or Wi-Fi for data input and output. In one embodiment, the network interface 1044 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Java, JavaScript, PHP, Python, Perl, Ruby, and AJAX. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use.

We claim:

1. A computer-implemented method in a user control server device, on a data communication network, for reducing false failed user card transactions by injecting user control for user card updates for card users by financial institutions during transactions transmitted from acquirer processors for approval by issuer processors, the method comprising:
receiving, at a user interface device of the recurring payment server device coupled to the data communication network, forwarded transactions from financial institutions, the forwarded transactions transmitted from a merchant device to an acquirer processor for approval upstream by an issuer processor;
identifying, with a processor coupled to the user interface device, from the forwarded transactions COF (card on file) merchants having payment credentials on file for a specific card user from a COF flag set in a network packet of the forwarded transactions;
compiling a list of COF merchants and transactions associated with each of the COF merchants;
providing the specific card user with a list of the COF merchants and associated transactions, along with one or more action buttons affecting the COF merchants;
receiving user input from the action button to implement a parameter for controlling transactions associated with a specific COF merchant; and
responsive to the user input, executing an action with respect to the specific COF merchant on a subsequent transaction received at the interface and concerning the specific COF merchant attempting a transaction concerning the specific card user.

2. The method of claim 1, further comprising:
determining that the COF merchant has set up recurring payments for the specific card user.

3. The method of claim 2, further comprising:
classifying recurring payments for the COF merchant from a history of transactions each associated with the COF merchant for the same amount or the same payment date over subsequent periods of time.

4. The method of claim 1, further comprising:
registering the financial institutions for forwarding transactions.

5. The method of claim 1, further comprising:
receiving user input from the action button; and
responsive to the user input, executing an action with the COF merchant.

6. The method of claim 1, further providing:
providing a status of the account update for the list of COF merchants or for recurring payments.

7. The method of claim 1, wherein the financial transactions are embedded within network packets according to the ISO 8583 format.

8. The method of claim 1, wherein the forwarded transactions are pre-processed to include acquirer identification, merchant identification, and terminal identification.

9. The method of claim 1, further comprising:
enriching data concerning the COF merchants, wherein the enriched data comprises one or more of an enriched merchant name, a merchant identification, a URL, a phone number, a merchant email, a COF or recurring indicator, recurring frequency, and subscription description.

10. The method of claim 1, further comprising:
providing updates to the specific card user to the list of the COF merchants and associated transactions, along with an action button related to updates of the COF merchants.

11. The method of claim 1, wherein the detected update comprises one or more of an account closure, a lost card, a stolen card, an expiration date.

12. A non-transitory computer-readable medium comprising source code that, when executed by a processor, performs a computer-implemented method in a user control server device, on a data communication network, for reducing false failed user card transactions by injecting user control for user card updates for card users by financial institutions during transactions transmitted from acquirer processors for approval by issuer processors, the method comprising:
receiving, at a user interface device of the recurring payment server device coupled to the data communication network, forwarded transactions from financial institutions, forwarded transmitted from an acquirer processor for approval by an issuer processor;
identifying, with a processor coupled to the user interface device, from the forwarded transactions COF (card on file) merchants having payment credentials on file for a specific card user, and participating in account update services for a financial institution;
providing the specific card user with a list of the COF merchants and associated transactions, along with an action button related to the COF merchants;
detecting an update to a card of the specific card user that will affect subsequent payments to the COF merchants has occurred based on receiving a notification from an issuer processor; and
automatically updating payment credentials with the COF merchants for the specific card user.
